(19) United States
(12) Patent Application Publication
(10) Pub. No.: US 2021/0399457 A1
(43) Pub. Date: Dec. 23, 2021

(54) PLUG CONNECTOR FOOR HIGH DATA RATE

(71) Applicant: HIRSCHMANN AUTOMOTIVE GMBH, Rankweil/Brederis (AT)

(72) Inventors: Ali Reza HAIDARI, Woergl (AT); Alexander DENZ, Feldkirch (AT); Manuel MAECHTINGER, Dornbirn (AT)

(21) Appl. No.: 17/279,125

(22) PCT Filed: Oct. 15, 2019
(86) PCT No.: PCT/EP2019/077914

§ 371 Date: Mar. 24, 2021

(30) Foreign Application Priority Data
Oct. 15, 2018 (DE) 10 2018 125 449.0

(51) Int. Cl. H01R 13/424; H01R 13/6592

(52) U.S. Cl. CPC H01R 13/424; H01R 2201/26; H01R 13/6592

(57) ABSTRACT

A plug connector having a contact support (2), wherein at least one contact chamber is provided in the contact support (2) and a contact partner (3) is inserted into the contact chamber and primarily locked therein, wherein each contact partner is allocated a throughgoing hole on one side of the contact support (2) for the primary latch formation and so as to increase the transmission rate, and a further single throughgoing hole is provided on the opposite side of the contact support (2), wherein the throughgoing holes have an elongated rectangular shape.

The invention relates to a plug connector for high data rates, in particular for a high-frequency band greater than 500 MHZ, preferably greater than 1 GHz, for applications in the automotive industry.

Plug connectors are known that comprise a contact support that is embodied from a synthetic material, wherein at least one contact chamber, preferably multiple contact chambers, are arranged in the contact support so as to receive in each case a contact partner. The contact partner is arranged at the end of an electrical conductor of an electrical cable, for example a sheathed cable, and the contact partner is inserted into its associated contact chamber. After it has been inserted, the contact partner is locked therein at least once (so-called primary latch formation). As a consequence, it is prevented that pulling and/or pushing forces on the electrical conductor or on the entire cable can cause the contact partner to move out of its contact chamber. This primary latch formation is realized in a known manner by virtue of the fact that the internal geometry of the contact support comprises an undercut (for example a shoulder) by means of which during the insertion procedure into the contact chamber an initially projecting resilient tab of the contact partner and then the somewhat compressed resilient tab can slide away if the contact partner is inserted into its contact chamber. If the contact partner is inserted in the proper manner into its contact chamber, the end of the resilient tab comes to rest against the undercut and locks the contact partner in its contact chamber.

A known plug connector comprises an elongated contact support having a somewhat rectangular or square cross-section.

The object of the invention is to improve such a plug connector for data transmission via the sheathed cable and the contact partners with respect to a mating plug connector for transmission rates (data rates) greater than 500 MHZ, preferably greater than 1 GHz.

The solution of this object provides that the undercut for the resilient tab (or the like) of the contact partner is formed in the contact support for each contact partner as a throughgoing hole in the contact support. As a consequence, the characteristics of the plug connector are considerably improved with regard to the technical aspects relating to high-frequency transmission with the result that as a consequence the data rates with which data are transmitted via the plug connector are likewise considerably increased.

In one development of the invention, it is provided that the square or rectangular cross-section of the contact chambers is provided in each case with a chamfer in the longitudinal direction in a corner of the square or of the rectangle. It is preferred that the contact chamber is embodied in a square or rectangular manner (viewed in the cross section) over its entire extension, wherein the chamfer is provided at least in the region of the throughgoing hole or in addition upstream or in addition downstream or over the entire longitudinal extension of the contact chambers.

In one development of the invention, it is provided that the throughgoing hole is provided for each contact chamber on the side of the contact support, lying there adjacent one another. The position of the respective throughgoing hole is either symmetrical or offset with respect to a longitudinal axis of the contact support, (the longitudinal axis when viewed from the plug-in direction with which the plug connector is plugged into a mating plug connector extends as far as the entry region of the cable at the opposite end).

In one development of the invention, at least one further throughgoing hole, preferably a single throughgoing hole, is arranged on the side which lies opposite the side that has the at least one throughgoing hole. Furthermore, this further throughgoing hole improves the characteristics of the plug connector with regard to the technical aspects relating to high-frequency transmission so as to increase the transmission rates. The throughgoing hole can be used but it is not necessary for it to be used for locking the contact partner that has been inserted therein into the contact chamber. Depending upon the number of contact chambers, it is also possible to provide multiple throughgoing holes. For example, for each two contact chambers in each case one throughgoing hole, alternatively for each two contact chambers in each case one throughgoing hole, are provided and so forth.

the increase in HF performance is realized by virtue of a geometric adaptation in the region of the primary contact latch formation (in other words in the region of the throughgoing holes that are located on one side of the contact support) and an additional housing hole that is located on the opposite side of the contact support. Both configurations do not have any influence on the mechanical functions for the use of such plug connectors in vehicles (automotive application).

In one development of the invention, the plug connector comprises at least one contact spring, preferably two contact springs that lie diametrically opposite one another or a circumferential contact spring. This at least one contact spring is operatively connected in an electrical manner to a shielding facility (for example a shielding braid) of the sheathed cable. The plug connector is connected via the at least one contact spring to a corresponding contact element for shielding purposes, wherein the corresponding contact element is arranged in or on a mating plug connector to which the plug connector can be plugged so as to form a plug connection. In lieu of such an at least one contact spring, it is also possible to use other contact elements that serve the purpose of making the connection so as to realize a throughgoing shielding arrangement between the plug connector and the mating plug connection

In one development of the, the plug connector is embodied for use in the automotive industry. Cables, in particular cable harnesses that are embodied from cables, are installed In modern vehicles, such as for example passenger cars or commercial vehicles, but also in agricultural vehicles, vehicles used in the construction industry and comparable vehicles, and plug connectors are arranged on the ends of the cables. It is not only energy (in particular for the voltage supply) that is transmitted via such plug connectors and the cables but also signals, for example sensor signals or actuator signals, are transmitted. In the case of this transmission, it is absolutely necessary to ensure a good shielding arrangement against external interfering influences and furthermore measures are necessary to ensure that the signals that are transmitted via the cables and the associated plug connectors are not radiated into the environment. This is above all particularly important in the case of applications in the automotive industry, where such cables and plug connectors are installed or arranged in part in the smallest space. For this reason, the plug connector in accordance with the invention can be used in a particularly advantageous manner in the automotive industry. This applies in addition or as an alternative also for the operation of the plug connector in a frequency band that is greater than 500 MHZ, preferably greater than 1 GHz. Particularly in the case of the transmission of signals at frequencies greater than 500 MHZ above all however in the case of transmission of signals at frequencies greater than 1 GHz, signals experience interference as a result of external influences, but possibly also as a result of interferences of the environment by radiation of the signals that are transmitted via the cable and the plug connector. It is also possible for this reason or only for this reason to use the plug connector in accordance with the invention in an advantageous manner in a frequency band greater than 500 MHZ. Furthermore, it is realized in an advantageous manner by the invention that the cable resistance remains as far as possible constant or almost unchanged not only over the extent of the cable (of the line) but also in the region of the plug connector. A further effect according to the invention is to be regarded in that by virtue of the presence of the at least one throughgoing hole a considerably improved shielding process with regard to transmission at high frequencies is realized between the individual contact partners, in particular between two contact partners that are arranged in their associated contact chambers. When such a plug connector is used for data transmission via the sheathed cable (also referred to as cable or line) and the contact partners to a mating plug connector for transmission rates (data rates) greater than 500 MHZ, preferably greater than 1 GHz, a considerably improved HF performance is consequently realized when the plug connector is used in the automotive industry but equally also in other technical application fields.

A plug connector in accordance with the invention is described below in detail and with the aid of the figures.

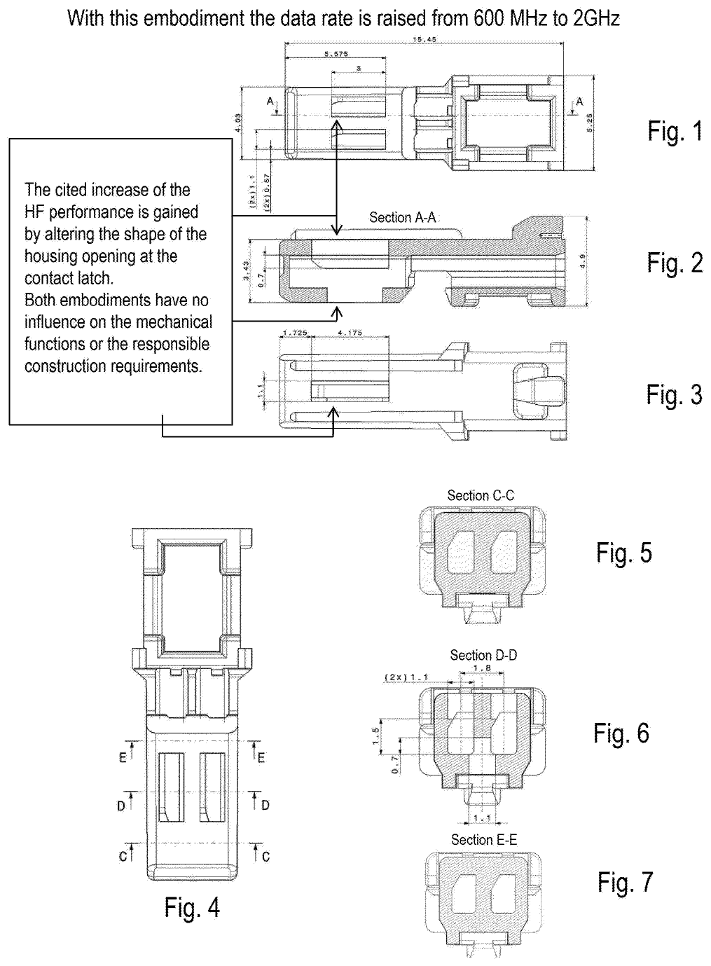

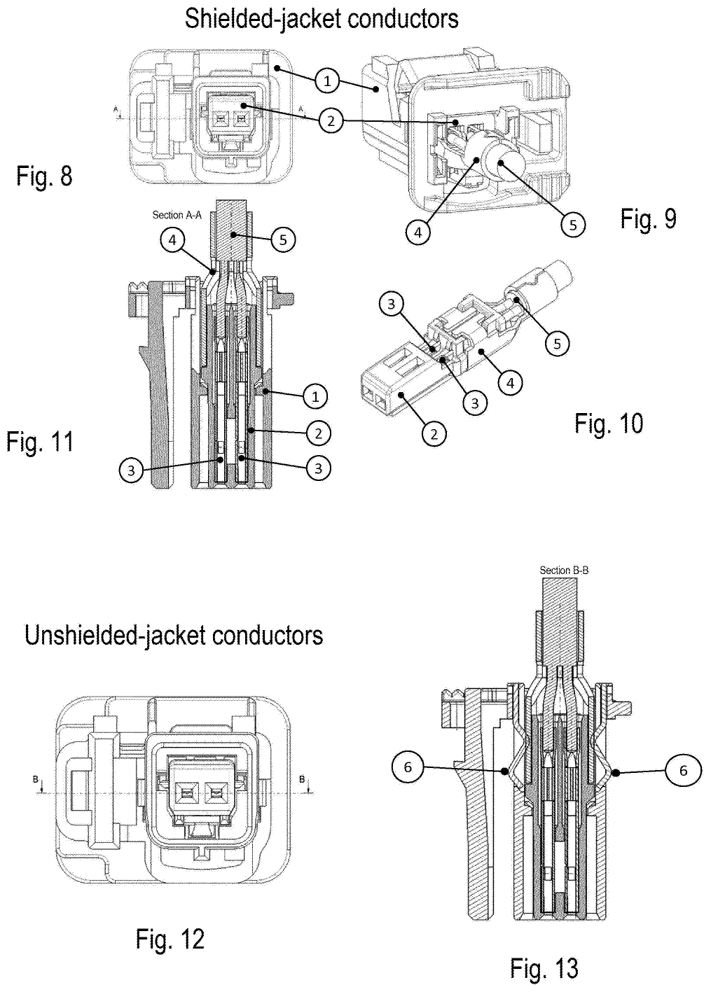

FIGS. 1 to 11 Illustrate a plug connector, wherein a contact support 2 is arranged in an outer housing 1 (also referred to as a protective collar). The outer housing 1 can be provided but it is not necessary to provide it. The contact support 2 illustrated in the FIGS. comprises two adjacent contact chambers into each of which a respective contact partner 3 is inserted. Each contact partner 3 is primarily locked in its associated contact chamber. This is performed for example by virtue of the fact that a resilient tab that projects from the contact partner slides along the inner face of the contact chamber (and is in so doing slightly compressed) when the contact partner 3 is inserted into its contact chamber. The resilient tab then assumes its original projecting position if the contact partner 3 is finally inserted in the proper manner into its contact chamber. In so doing, the resilient tab comes to rest against an undercut. The undercut in the case of the plug connector of this embodiment is configured as a throughgoing hole in the contact support. The respective throughgoing hole in the contact support 2 is configured in an elongated manner and preferably with a rectangular cross-section (when viewing a plan view of the contact support 2 on its upper face). The contact partner 3 that is inserted into its contact chamber is accessible via this throughgoing hole but this is not important for the operation of the plug connector. This throughgoing hole is important with respect to the characteristics of the plug connector with regard to the technical aspects relating to high-frequency transmission since the data rates are thereby considerably increased. For example when viewing FIG. 10, it is clear that two throughgoing holes are arranged adjacent one another on one side of the contact support 2. In this case, the two adjacent throughgoing holes are symmetrical with respect to the longitudinal axis of the elongated contact support 2. As an alternative to such a symmetrical arrangement, an asymmetrical arrangement is also possible. It is preferred that the narrow ends of the throughgoing holes are aligned with one another but it is not necessary.

With reference to FIG. 9 for example, reference is also made to a strain relief 4 of a sheathed cable 5 to which the plug connector is connected. The sheathed cable 5 that is unshielded in this case is for example an electrical cable of the type that comprises at least one internal electrical conductor (in the case of the embodiment two internal electrical conductors) that are surrounded by an outer sheath. If a shielded sheathed cable is involved (see FIGS. 11 and 12), a shield, for example a shielding braid or a shielding film, is arranged in a coaxial manner within the outer sheath and surrounds the at least one internal electrical conductor. This shield is electrically contacted by at least one contact spring 6 of the plug connector. The connection to a corresponding shield of a mating plug connector (not illustrated here) is produced by the contact spring 6.

FIGS. 4 to 7 illustrate the position of the throughgoing holes that are used to provide the primary latch formation of the contact partner within its contact chambers, and at least one opposite-lying throughgoing hole preferably so as to further increase the performance of the plug connector with regard to the technical aspects relating to high-frequency transmission.

FIG. 4 illustrates the contact support 2, viewed from above, in which 2 throughgoing holes are arranged. In this case, there are precisely two throughgoing holes since the electrical cable also comprises two electrical conductors and contact partners that are accordingly arranged thereon. However, where appropriate, it is also possible to provide only one throughgoing hole or also more than two throughgoing holes can be provided on this side of the contact support 2, wherein this is governed by the number of the electrical conductors of the cable.

FIGS. 5 and 7 illustrate the cross-section of a respective contact chamber upstream and downstream of the throughgoing hole in accordance with FIG. 4. The cross section in this case is rectangular with a chamfer in a corner of the rectangle. A square cross-section having a corresponding chamfer is also possible.

FIG. 6 illustrates the situation of the contact chambers in the region of the two throughgoing holes that are shown at the top (when viewing FIG. 6). It is apparent that these two throughgoing holes that are shown at the top comprise the same cross-section as also in the region upstream and downstream of the throughgoing holes. Furthermore, is apparent that a further throughgoing hole is provided opposite the two throughgoing holes. This further throughgoing hole is arranged in a symmetrical manner with respect to the longitudinal axis and the vertical axis of the contact support shown in FIG. 6. When viewing FIG. 6, it is apparent a remaining web is shown somewhat in the top half of the contact chambers, wherein in addition free space is created somewhat in the lower half of the contact chambers and the free space extends as far as the further throughgoing hole. As a consequence, a free space is provided that continues from the lower face of the contact support via the further throughgoing hole, via the contact chambers and via the top adjacent throughgoing holes, by means of which the characteristics of the plug connector with regard to the technical aspects relating to high-frequency transmission are improved, in particular the transmission rates are considerably increased. This naturally also applies if a contact partner is inserted into the respective contact chamber. This situation is clearly apparent in FIGS. 4 to 7 by the respective sectional views.
500 MHZ=500 Megahertz
1 GHz=1 Gigahertz

### LIST OF REFERENCE NUMERALS

1 Outer housing
2 Contact support
3 Contact partner
4 Strain relief
5 Sheathed cable
6 Contact spring

1. A plug connector comprising:
a contact support forming a contact chamber and having a pair of opposite sides each formed with a respective throughgoing hole of elongated rectangular shape; and
a contact partner in the contact chamber and having a primary latch formation primarily locked in one of the throughgoing holes.

2. The plug connector according to claim 1, wherein an undercut is formed by the throughgoing hole for the primary latch formation and by the undercut during the insertion procedure into the contact chamber an initially projecting resilient tab of the contact partner and then the somewhat compressed resilient tab can slide away if the contact partner is inserted into its contact chamber, wherein then if the contact partner is inserted in the proper manner into its contact chamber, the end of the resilient tab comes to rest against the undercut and locks the contact partner in its contact chamber.

3. The plug connector according to claim 1, wherein the cross-section of the contact chamber is square or rectangular with a chamfer in the longitudinal direction in a corner of the square or of the rectangle.

4. The plug connector according to claim 1, there are two of the contact changers each with two of the throughgoing holes and the holes on one side of the contact support are adjacent one another.

5. The plug connector according to claim 1, further comprising:
at least one contact spring.

6. The plug connector according to claim 1, further comprising:
a circumferential contact spring.

7. The plug connector according to claim 1, wherein the plug connector is embodied for use in the automotive industry.

8. The plug connector according to claim 1, wherein the plug connector is embodied for use in a frequency band greater than 500 MHZ.

9. The plug connector according to claim 1, wherein the plug connector is embodied for use in a frequency band greater than 1 GHz.
